(19) United States
(12) Patent Application Publication
(10) Pub. No.: US 2010/0192837 A1
(43) Pub. Date: Aug. 5, 2010

(54) Golf club reminder clip

(76) Inventors: Erik C. Leoni, Huntington Beach, CA (US); Sheri L. Baker, Huntington Beach, CA (US)

Correspondence Address: Erik C. Leoni, 626 Lake St #59, Huntington Beach, CA, 92648, US

(21) Appl. No.: 12/657,714

(22) Filed: Jan. 27, 2010

Related U.S. Application Data
(60) Provisional application No. 61/202,166, filed on Feb. 3, 2009.

(51) Int. Cl. G09F 9/00

(52) U.S. Cl. 116/307

(57) ABSTRACT

A golf reminder clip of the present invention includes a clip member adapted to be attached to the shaft of a golf club (particularly a wedge) when the club is housed in a golf bag. An octagonal tag is hinged to the clip member. The front face of the tag is inscribed with indicia that remind the golfer that the wedge has not been replaced.

We claim the priority of provisional patent application No. 61/202,166 filed on Feb 3, 2009.

### BACKGROUND OF THE INVENTION

1. Field of the Invention

The present invention generally relates to golf accessories, and more particularly to a golf club reminder clip for indicating the absence of a golf club from a golf bag.

2. Description of the Related Art

Golf clubs are generally carried in a golf bag, which is usually carried in a hand or on a motorized golf cart. Most conventional golf bags are partitioned so that the clubs may be organized in the bag according to the length and face angle of the club. When a situation demands a particular club, the club is retrieved from the bag, the shot executed and the club replaced. Since most golf courses do not permit carts in areas immediately around greens, the golfer, in some instances, must remove two clubs from the bag (a wedge for stroking the ball from the area adjacent the green to the green and a putter for holing out).

More often than not, the wedge is deposited on the ground while the golfer uses the putter to hole out. Unfortunately, in the excitement of making par or less or the consternation of having to settle for a bogie, the wedge is forgotten and is not missed until it is needed on a subsequent hole. This scenario often results in the forgotten club being lost or damaged resulting in replacement or repair costs. The golfing industry would certainly welcome an inexpensive device that could be utilized to remind the golfer that a club is missing from the bag before the golfer proceeds to the next hole. Thus, a golf club reminder clip solving the aforementioned problems is desired.

### SUMMARY OF THE INVENTION

The golf reminder clip is a hinged device comprising a clip member adapted to be attached to the shaft of a golf club (particularly a wedge) when the club is housed in a golf bag. An octagonal tag is hinged to the clip member. The front face of the tag is inscribed with indicia that remind the golfer that the wedge has not been replaced.

Accordingly, the invention presents a reminder device for golfers that is easy to use and effectively reminds a golfer that the wedge has not been replaced in the golf bag. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1A is an environmental, perspective view of a golf club reminder clip according to the present invention, shown attached to a golf club.

FIG. 1B is an environmental, perspective view of a golf club reminder clip according to the present invention, shown attached to a golf bag.

FIG. 2 is an exploded front view of a golf club reminder clip according to the present invention.

FIG. 3 is a perspective view of a golf club reminder clip according to the present invention.

Similar reference characters denote corresponding features consistently throughout the attached drawings.

### DETAILED DESCRIPTION OF THE PREFERRED EMBODIMENTS

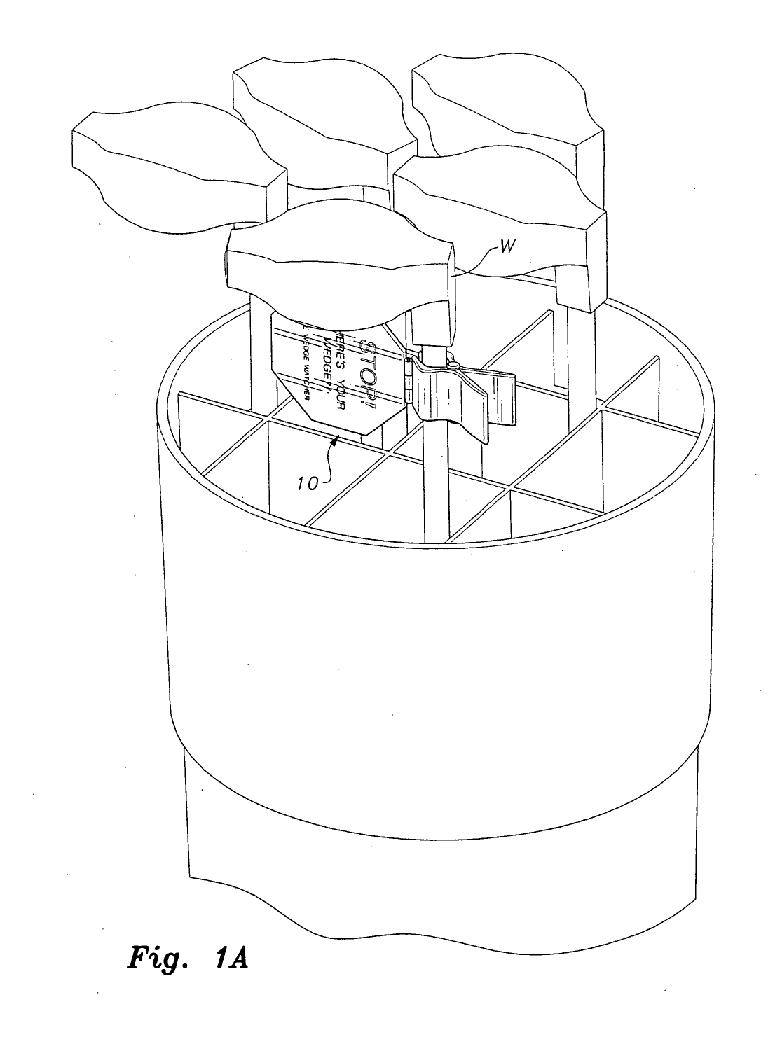

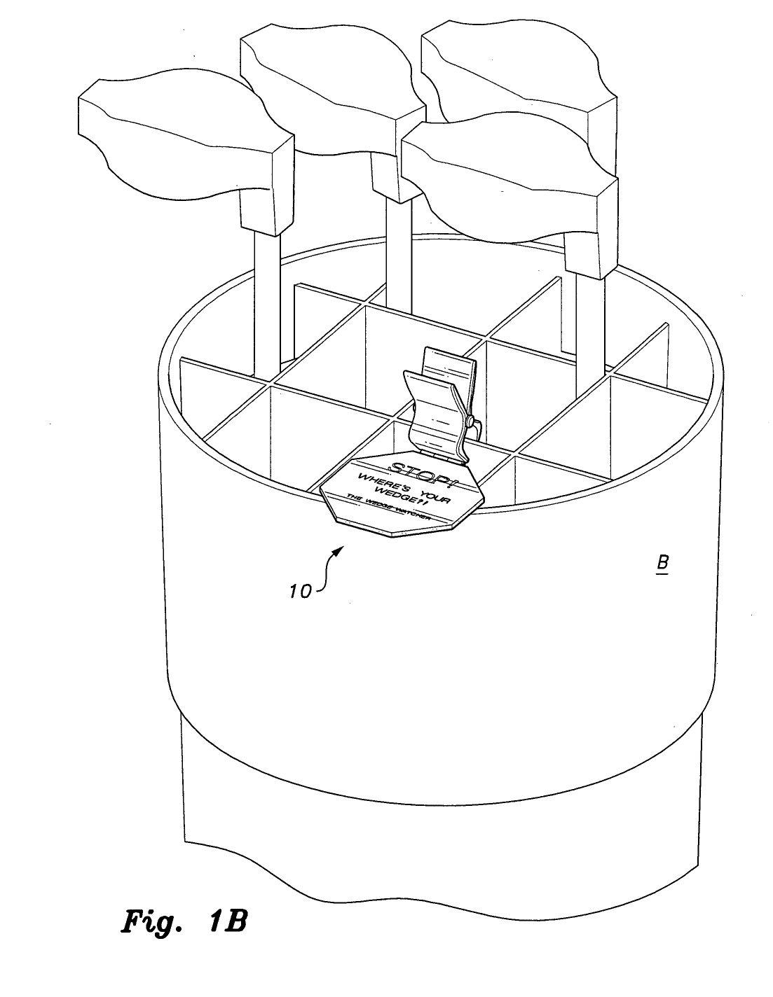

Attention is first directed to FIGS. 1A and 1B. wherein the golf club reminder clip is generally indicated at 10. In FIG. 1A, clip 10 is attached to the shaft of a golf club W (normally a wedge). In FIG. 1B, the clip 10 is attached to the golf bag B after the wedge has been removed.

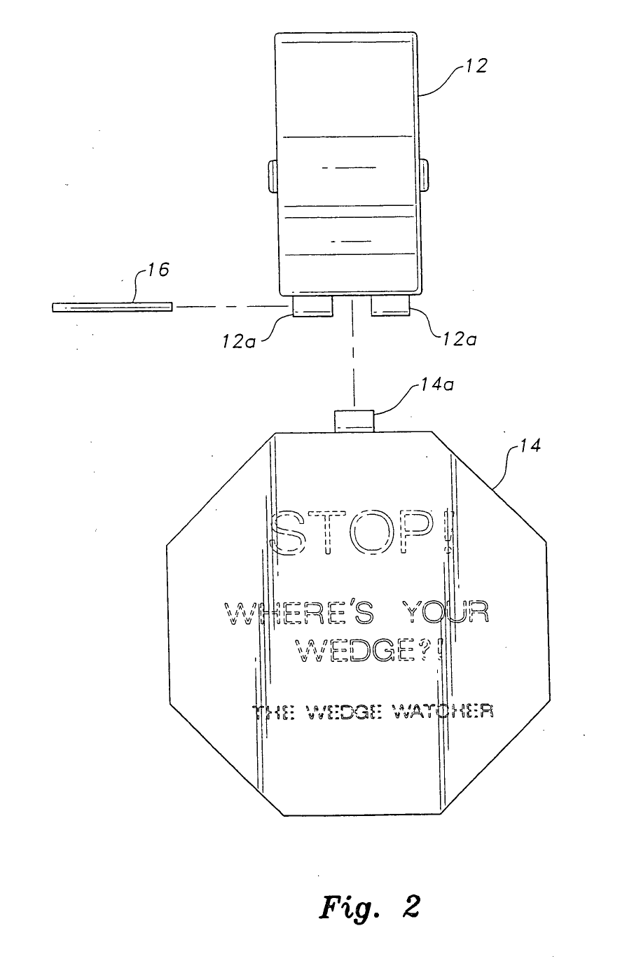

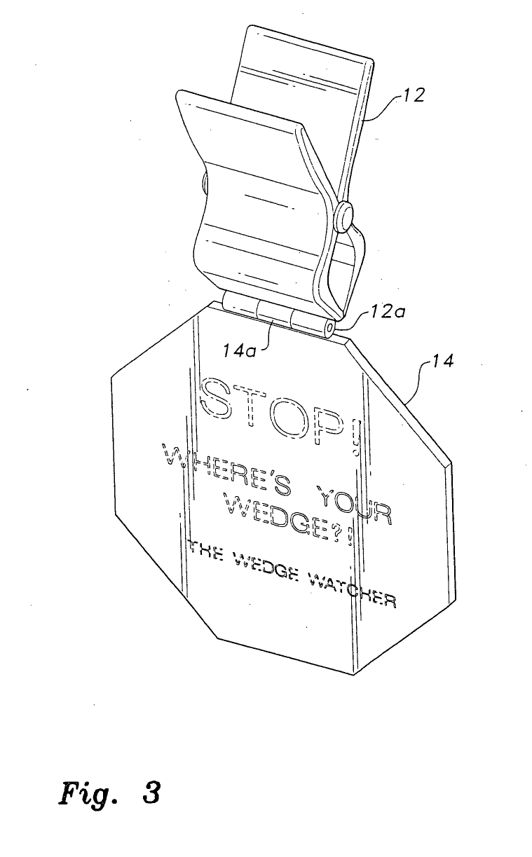

As best seen in FIGS. 2 and 3, clip 10 comprises a spring-loaded clip member 12 hinged to a tag member 14. A hinge pin 16 is employed to connect clip member 12 to tag member 14 via lugs 12a and 14a. Tag member 14 has an octagonal shape (stop sign) and is inscribed with reminder indicia on its front face. The jaws of the clip member 12 are dimensioned to fit around the shaft of a golf club.

In use, the clip 10 is attached to the club when the club is housed in the golf bag. When the club is removed, the clip 10 is attached to the bag. If the golf bag is compartmentalized and a wedge and a putter are removed, the clip 10 can be attached to cover the putter compartment, thereby preventing the golfer from replacing the putter without checking for the presence of the wedge.

It is to be understood that the present invention is not limited to the embodiment described above, but encompasses any and all embodiments within the scope of the following claims.

We claim:

1. A golf club reminder device, comprising:
a spring-loaded clip member having jaws dimensioned to fit around the shaft of a golf club; and
an octagonal tag member, the octagonal tag member being pivotally attached to the clip member.

2. The golf club reminder device according to claim 1, further including indicia inscribed on a face of said octagonal tag member.
